(19) United States
(12) Patent Application Publication
(10) Pub. No.: US 2026/0142533 A1
(43) Pub. Date: May 21, 2026

(54) PUMP

(71) Applicant: MAHLE International GmbH, Stuttgart (DE)

(72) Inventor: Dieter Hoehn, Hildburghausen (DE)

(21) Appl. No.: 19/396,300

(22) Filed: Nov. 20, 2025

(30) Foreign Application Priority Data
Nov. 21, 2024 (DE) 102024134247.1

(51) Int. Cl. H02K 9/197; H02K 11/215; H02K 11/25

(52) U.S. Cl. CPC H02K 9/197; H02K 11/215; H02K 11/25; H02K 2211/03

(57) ABSTRACT

A pump may include an electric motor, a printed circuit board, an elastic seal, and at least two fixing elements. The motor may include a rotor and a stator surrounding the rotor. The stator may be overmolded with a plastic sheath and may have an opening on a front side. The printed circuit board may seal the opening in a fluid-tight manner and may, together with the stator, delimit an interior space through which coolant is flowable. The rotor may be arranged in the interior space. The elastic seal may be arranged between the plastic sheath and the printed circuit board. The at least two fixing elements may be arranged on the front side of the stator. The at least two fixing elements may be connected to the printed circuit board via a plurality of fixing contours.

### CROSS-REFERENCE TO RELATED APPLICATION

This application claims priority to German Patent Application No. DE102024134247.1, filed on Nov. 21, 2024, the contents of which is hereby incorporated by reference in its entirety.

### TECHNICAL FIELD

The present invention relates to a pump with an electric motor having a rotor and a stator surrounding it, which is overmolded with a plastic sheath and has an opening at the front end.

### BACKGROUND

WO 2024/044 988 A1 discloses an electric motor designed as a pump, comprising a housing with a receiving cavity, wherein the housing is provided with a first opening; a stator arranged in the receiving cavity; a rotor arranged in the stator, wherein the rotor comprises a first end portion that passes through the housing and is used to deliver torque to the outside. Coolant can be directed to a printed circuit board via a first opening in a wall portion of the first receiving cavity, thereby extending the service life of the printed circuit board.

EP 1 503 083 A1 discloses a generic electric pump for cooling circuits of internal combustion engines, comprising an electric motor with a rotor and a stator surrounding the rotor, which has an opening at the front end, and with a printed circuit board which seals the end opening in a fluid-tight manner and, together with the stator, delimits an interior space through which coolant can flow, in which the rotor is arranged. The stator is overmolded with a plastic sheath.

The pump known from the prior art enables a design without the previously required containment shell for separating a wet region from a dry region, thereby achieving a space-optimized and cost-effective design compared to a design with a containment shell. However, the disadvantage of this design is that it can lead to leaks at the connection between the printed circuit board and the plastic sheath of the stator and/or in the plastic sheath itself, particularly due to the inflexible connection between the two components. Due to capillary action, such leaks can cause coolant to reach electrical components, in particular an electrical connection between the printed circuit board and the stator, where it can cause malfunctions, which must be avoided at all costs. Coolant could also seep along the electrical connection through regions that are actually fluid-tight, causing damage.

### SUMMARY

The present invention therefore addresses the problem of providing an improved or at least alternative design for a pump of the generic type, by means of which the disadvantages known from the prior art can be overcome in particular.

According to the invention, this problem is solved by the subject matter of the independent claim(s). Advantageous embodiments are the subject matter of the dependent claim(s).

The present invention is based on the general idea of delimiting and sealing the interior space of a fluid-cooled pump, in which a rotor of the pump is located, without a separate containment shell, but only by means of a stator having an end opening and a printed circuit board connected to it in a fluid-tight manner via an elastic seal, which closes the end opening. This embodiment eliminates the need for a containment shell and improves cooling of the printed circuit board, which is in direct contact with the coolant, and the electronic components arranged thereon. At the same time, the elastic seal between the plastic sheath and the printed circuit board reliably prevents unwanted leakage of coolant and, in particular, contact with electrical components. In order to make the seal both elastic and reliably fluid-tight, a connection between the printed circuit board and the plastic sheath of the stator is also created by means of at least two fixing elements.

The pump according to the invention has an electric motor with a rotor and a stator surrounding it and overmolded or coated with a plastic sheath, which has the front opening described above. The plastic sheath is in particular inseparably connected to the stator. A printed circuit board is also provided, which seals the front opening of the stator or the plastic sheath in a fluid-tight manner and, together with the stator, in particular the plastic sheath of the stator, delimits an interior space through which coolant can flow and in which the rotor is arranged. According to the invention, an elastic, in particular rubber-elastic, seal is now arranged between the plastic sheath of the stator and the printed circuit board, and at least two fixing elements are arranged on the front side of the plastic sheath of the stator, which interact with or are connected to fixing contours on the printed circuit board and thereby fix the printed circuit board relative to the plastic sheath. According to one embodiment, the fixing elements are connected to the plastic sheath in a fixed position. According to one embodiment, the fixing elements are integrally formed with the plastic sheath. According to a particular embodiment, the fixing elements extend through the plastic sheath to the printed circuit board, wherein at least one of the fixing elements is designed as an electrical conductor that makes electrical contact between the stator and the printed circuit board and is soldered to the printed circuit board. This means that any electrical contact between the printed circuit board and the stator required to operate the pump can also be used to fix the printed circuit board in relation to the stator or the plastic sheath. The plastic sheath thus extends at least to the front opening of the stator, in particular providing a contact surface for the elastic seal. In particular, the plastic sheath also extends along a side of the stator facing the rotor. It is preferable for the seal to be compressed elastically, at least in part, by the interaction of the fixing contours and the fixing elements, thereby providing a seal between the plastic sheath and the printed circuit board. Preferably, the fixing elements are connected to the fixing contours in such a way that a force flow is established via the seal, the fixing contours of the printed circuit board, the fixing elements, and the plastic sheath, the force of which elastically compresses the seal. The elastic seal ensures reliable sealing of the interior space against the outside. At the same time, the risk of microcracks forming in the connection region between the printed circuit board and the plastic sheath of the stator or in the plastic sheath itself, which could lead to leaks in the interior space, can at least be reduced. The at least two fixing elements, which are arranged, for example, opposite each other or evenly distributed over a circumference of the front opening on an opening edge, enable the printed circuit board and the stator to be reliably and permanently connected to each other, for which purpose, for example, only the printed circuit board with its fixing contours needs to be positioned or aligned in such a way that they can be fixed to each other. Once the printed circuit board with its fixing contours has been placed on the fixing elements, the printed circuit board is pressed against the seal located underneath and, in particular, a connection between the fixing elements and the fixing contours is then provided. The pump according to the invention thus makes it possible, on the one hand, to dispense with a separate containment shell that has been used up to now and, on the other hand, to achieve reliable sealing of the interior space.

Since the interior space is directly limited by the printed circuit board, it can be brought into direct contact with the coolant without an intermediate containment shell, resulting in significantly improved cooling. The elimination of the containment shell not only reduces the number of parts and thus the complexity of the pump, but also lowers manufacturing, storage, logistics, and assembly costs. This makes the pump more robust. The elimination of a separate containment shell also simplifies the assembly sequence and achieves an overall compact design, as the installation space previously required for the containment shell is now freed up. In addition, a so-called gap filler, which was previously used to establish a heat-transferring contact between the containment shell and the printed circuit board, can also be omitted.

The elastic seal preferably extends around the interior space, generally in any shape, but particularly annular. In an advantageous further development of the pump according to the invention, a sealing groove, in particular an annular groove, is arranged on the front side of the plastic sheath of the stator to accommodate the elastic seal. Such a sealing groove or annular groove is open in the direction of the printed circuit board, so that the seal arranged therein, for example an O-ring seal or an X-ring seal, can be easily positioned with precise positioning and the sealing effect can be achieved by simply placing the printed circuit board on top. Such a sealing groove can be produced using a suitable plastic injection molding tool when overmolding the stator with plastic and therefore does not require any further work steps.

The elastic seal is conveniently designed as a ring seal, in particular as an O-ring seal or as an X-ring seal. O-ring seals are widely known and used, allowing for individual adaptation to, for example, a cooling medium located in the interior space, depending on the manufacturer. When designing the elastic seal as an X-ring seal, an advantage over an O-ring seal can be achieved in that two sealing lips are provided, each of which has a sealing surface, thereby further improving the sealing effect.

In an advantageous further development of the pump according to the invention, the elastic seal is designed as a sealing lip, which is in particular molded onto the plastic sheath. This offers the major advantage that sealing between the plastic sheath of the stator on the one hand and the printed circuit board on the other is achieved via the sealing lip on the plastic sheath side, without the need to provide and install a separate seal. Another major advantage of a sealing lip molded onto the opening edge of the plastic sheath is that the seal can be manufactured together with the plastic sheath when overmolding the stator. It is conceivable that the sealing lip could be made from a different plastic than the plastic sheath of the stator, in which case a 2K plastic injection-molded part would be produced. In purely theoretical terms, it is of course also conceivable that both a ring seal and a sealing lip could be provided in order to further improve the seal.

In a particularly preferred embodiment, the fixing elements are designed as thermal contact rivets, wherein the printed circuit board has at least two through-openings designed to complement the thermal contact rivets, through which the thermal contact rivets are guided. The at least two thermal contact rivets enable the printed circuit board and the stator to be reliably and permanently joined together using a thermal contact riveting process, for which, for example, only the printed circuit board with its openings needs to be positioned or aligned so that the openings and the thermal contact rivets on the plastic sheath side are aligned with each other. Once the printed circuit board with its openings has been placed on the thermal contact rivet, the printed circuit board is pressed against the seal located underneath and then the thermal contact rivet is hot-formed, creating a rivet head which, once cooled, reliably secures the printed circuit board to the stator.

Alternatively, it is also conceivable that the fixing elements are designed as latching elements, wherein the printed circuit board has at least two latching contours designed to complement the latching elements, with which the latching elements are latched. It is particularly preferable for the latching contours to be arranged on a radial outer side of the printed circuit board. This means that the latching contours are formed by part of the outer contour of the printed circuit board. This offers the great advantage that no openings need to be provided in the printed circuit board, as it can be gripped at the edges by the latching elements. In addition, the position of the fastening elements can be moved outwards as far as possible to optimize the installation space. This also allows a detachable yet fluid-tight connection to be created between the printed circuit board and the stator, whereby detaching the latching elements provides access to the interior space (rotor chamber) and can facilitate repairs, for example.

In another advantageous embodiment of the pump according to the invention, the printed circuit board has at least one sensor, in particular a temperature sensor and/or a Hall sensor.

It is particularly preferable for the sensor to be arranged on a side facing the interior space. This improves measurement accuracy. If, for example, a temperature sensor is arranged on the side facing the interior space, this makes it relatively easy, accurate, and quick to measure the temperature of the coolant, enabling fast and reliable control and regulation of the pump. In general, the aim is to arrange all electronic components on a side of the printed circuit board that faces away from the interior space, thereby protecting them.

If the sensor is designed as a Hall sensor, the pump preferably has a magnet corresponding to the Hall sensor, which is connected to the rotor in a fixed position. The interaction between the Hall sensor and the magnet enables the rotation and/or relative position of the rotor to be detected. It is particularly preferable for the magnet to be arranged on the shaft. In particular, the magnet is connected to the rotor and/or the shaft in a positionally fixed manner by at least partial overmolding.

For the most accurate evaluation possible, it is advisable to position the Hall sensor and the magnet as close together as possible. According to a preferred embodiment, the Hall sensor and the magnet are therefore spaced apart by a maximum of 4 mm, in particular a maximum of 3.5 mm.

For practical reasons, the printed circuit board has a coating on the side facing the interior space. Providing such a coating can protect the printed circuit board from the coolant and from abrasive particles carried by it, and ensures improved mechanical and chemical resistance. The coating mentioned can also reduce the formation of microcracks and the risk of coolant entering/penetrating the printed circuit board. Such a coating can be made of silicone or epoxy resin, for example. If the coolant is neither electrically conductive nor abrasive, such as oil, this coating is not necessary and improved cooling of the printed circuit board can be achieved.

According to an advantageous embodiment, the elastic seal lies directly against the coating of the printed circuit board. By providing the coating in the region of the seal, a continuously closed sealing surface is provided for sealing in the region of the seal.

Of course, it is also conceivable that the printed circuit board has no coating, but that the material of which the printed circuit board is made, for example a class of printed circuit board base material consisting of an in particular flame-retardant epoxy resin-glass fabric composite, e.g., FR-4, which is already sufficient to provide adequate fluid tightness and wear resistance.

In another advantageous embodiment of the pump according to the invention, reinforcing structures, for example stiffening ribs, are arranged on the plastic sheath. Such reinforcement structures can, for example, be formed in the manner of a lattice structure on the plastic sheath of the stator. Since the plastic sheath is exposed to the pressure of the coolant during pump operation, and in particular to pressure pulsations and stresses on the fixing elements, such reinforcement structures can be used to stiffen the plastic sheath, enabling it to withstand higher mechanical loads. Such reinforcing structures, in particular stiffening ribs, can be designed as webs, for example. Such reinforcing structures can be formed in one piece with the plastic sheath.

In a particularly preferred embodiment of the pump according to the invention, the plastic sheath completely covers the stator on a side facing the rotor, in particular with a thickness of at most 4 mm, in particular at most 1 mm, in particular at most 0.5 mm, and/or at least 0.3 mm. On the one hand, such a thin plastic layer as possible allows reliable encapsulation of the stator to be achieved and, on the other hand, minimizes the gap between the stator and the rotor, which means that the efficiency of the electric motor is not affected, or only marginally so.

The pump can be designed, for example, as an oil pump, particularly in a motor vehicle, although other embodiments, such as a coolant pump, particularly a water pump, are of course also conceivable.

Advantageously, the fixing elements are arranged outside the elastic seal in a dry region. The elastic seal is thus located radially within the fixing elements in a circular cross-section. This separates the fixing elements from the coolant.

Further important features and advantages of the invention will become apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral regions or portions of this unit, even if this is shown differently in the drawings.

Preferred exemplary embodiments of the invention are shown in the drawings and are explained in more detail in the following description, wherein identical reference numerals refer to identical or similar or functionally identical components.

### BRIEF DESCRIPTION OF THE DRAWINGS

They show, each schematically,

FIG. 1 shows a cross-sectional view of a pump according to the invention,

FIG. 2 shows an oblique view of the pump's stator.

### DETAILED DESCRIPTION

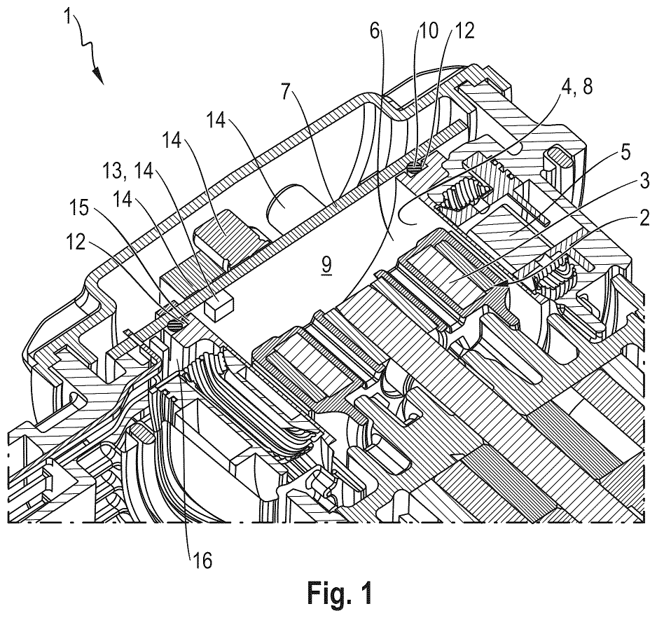

According to FIG. 1, a pump 1 according to the invention, which can be designed, for example, as an oil pump or a coolant pump, has an electric motor 2 with a rotor 3 and a stator 5 surrounding the rotor and overmolded with a plastic sheath 4. The plastic-coated stator 5 or plastic sheath 4 has an opening 6 at the front end which, as shown in FIG. 1, is sealed fluid-tight by a printed circuit board 7 with respect to a coolant flowing in an interior space 9 (rotor chamber). This printed circuit board 7, together with the plastic sheath 4 or its inner sheath surface 8, thus delimits the interior space 9 through which coolant can flow and in which the rotor 3 is rotatably arranged.

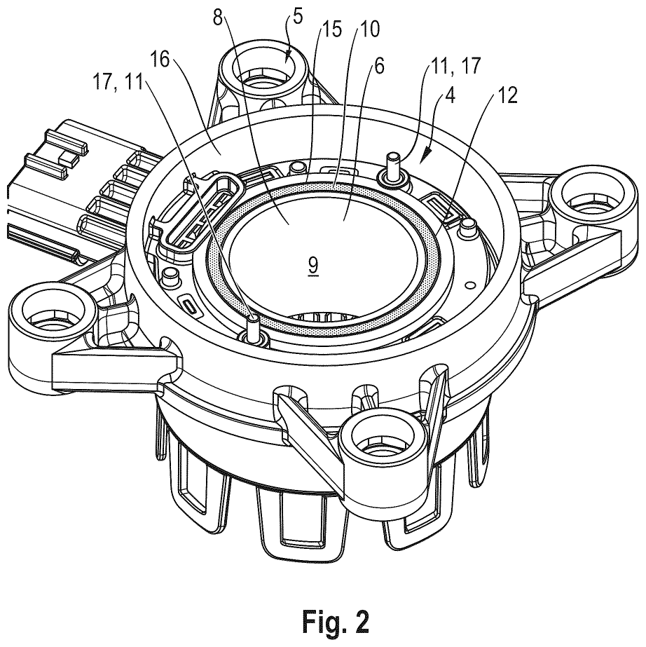

According to the invention, an elastic seal 10 is now arranged between the plastic sheath 4 and the printed circuit board 7, and at least two fixing elements 11 are arranged on the front side of the stator 5 or its plastic sheath 4, as shown in FIG. 2, which interact with fixing contours on the printed circuit board 7. The at least two fixing elements 11 are arranged outside the elastic seal 10 in a dry region 16. The elastic seal 10 is thus located radially within the at least two fixing elements 11 in a circular cross-section. This separates the at least two fixing elements 11 from the coolant.

In the present case, the printed circuit board 7 has at least two openings that are complementary to the at least two fixing elements 11 designed as thermal contact rivets 17, through which the thermal contact rivets 17 are guided when the pump 1 is mounted. The at least two openings in the printed circuit board 7 are located outside the section plane as shown in FIG. 1 and are therefore not shown.

The printed circuit board 7 directly bordering the interior space 9 makes it possible to cool the printed circuit board 7 directly, thereby eliminating the need for a containment shell previously arranged between the printed circuit board 7 and the interior space 9. This not only reduces the variety of parts, but also associated storage and logistics costs as well as assembly costs. The fact that the containment shell is no longer required also frees up installation space, allowing the pump 1 according to the invention to be constructed in a more compact manner overall. The elimination of the previously required containment shell also eliminates the need for thermal paste (gap filler) connecting it to the printed circuit board 7, thereby eliminating another component and saving costs and installation space.

Looking further at FIGS. 1 and 2, it can be seen that an annular groove 12 for receiving the elastic seal 10 is arranged on the front side of the stator 5 and the plastic sheath 4, respectively. In the case shown, seal 10 is designed as an O-ring seal in accordance with FIGS. 1 and 2, which makes it not only cost-effective but also possible to manufacture in almost any configuration.

In contrast to a seal 10 designed as an O-ring seal, it can also be designed as an X-ring seal, which offers the great advantage that such an X-ring seal can provide two sealing lips and thus two sealing surfaces, both against the printed circuit board 7 and against the annular groove 12, thereby achieving a further improved seal.

In order to determine the temperature of the coolant present in the interior space 9, a sensor designed as a temperature sensor 13 (see FIG. 1) may be arranged on a side of the printed circuit board 7 facing the interior space 9. The temperature sensor 13 preferably represents the only electronic component 14 of the printed circuit board 7 that is arranged on the side of the printed circuit board 7 facing the interior space 9. All other electronic components 14 are arranged on the side of the printed circuit board 7 facing away from the interior space 9 and therefore do not come into contact with the coolant flowing in the interior space 9. This allows reliable and accurate temperature measurement of the coolant to be achieved on the one hand, and on the other hand, all other electronic components 14 can be protected and arranged on a side of the printed circuit board 7 that is not exposed to the coolant. In addition or alternatively, a sensor arranged in the interior space 9 or on the side of the printed circuit board 7 facing away from the interior space 9 may also be designed as a Hall sensor.

In general, the aim is to arrange all electronic components 14, including the temperature sensor 13, on the side of the printed circuit board 7 facing away from the interior space 9, thereby protecting them from direct contact with the coolant.

In order to ensure the tightness and integrity of the printed circuit board 7, it may have a coating on the side facing the interior space 9, for example an elastic and coolant-resistant protective lacquer. However, providing such a coating protects the printed circuit board 7 primarily from the coolant and the abrasive particles it carries, thereby improving its mechanical and chemical resistance. Such a coating can generally be advantageous, for example, made of silicone or epoxy resin. If the coolant is neither electrically conductive nor abrasive, such as oil, such a coating is not necessary and improved cooling of the printed circuit board 7 can be achieved.

In general, such a coating on the printed circuit board 7 can also be dispensed with, in particular if the material of the printed circuit board 7 is, for example, a class of printed circuit board base material made of a flame-retardant epoxy resin-glass fabric composite material, e.g., FR-4, which is already sufficient to provide adequate fluid tightness.

The plastic sheath 4 completely covers the stator 5 on a side facing the rotor 3, in particular with a thickness between 0.3 mm and 0.5 mm. The plastic sheath 4 can thus have a thickness of preferably approx. 0.5 mm on a side facing the rotor 3, which on the one hand enables complete encapsulation of the stator 5 and on the other hand does not unnecessarily increase the distance between the rotor 3 and the stator 5, thereby unnecessarily reducing the efficiency of the electric motor 2.

Compared to similar pumps known from the prior art, the pump 1 according to the invention makes it possible to have, in particular at a transition from the printed circuit board 7 to an opening edge 15 of the opening 6 of the stator 5 or the plastic sheath 4, not a rigid connection but rather an at least limited elastic connection whose susceptibility to cracking is significantly reduced. The elastic seal 10, regardless of whether it is designed as an O-ring seal, an X-ring seal, or a sealing lip molded onto an opening edge 15 of the plastic sheath 4, allows at least slight relative movement between the printed circuit board 7 and the seal 10 while maintaining a sufficient sealing effect.

In contrast to a seal 10 designed as a separate ring seal, such an elastic seal 10 can also be designed as a sealing lip molded onto an opening edge 15 of the opening 6 of the plastic sheath 4, so that in this case the seal 10 can be manufactured in one piece with the plastic sheath 4 and thus together with it. It is, of course, conceivable that different plastics can be used for the sealing lip and the plastic sheath 4, so that, for example, a particularly elastic, especially rubber-elastic plastic can be used for the sealing lip, which can develop a high sealing effect. In this case, it is a so-called 2K plastic injection-molded part. The advantage of this type of injection-molded sealing lip is that no separate O-ring or X-ring seal needs to be produced, stored, or installed, which reduces not only manufacturing costs but also storage and logistics costs and, as a result, installation costs.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A pump, comprising:
an electric motor including a rotor and a stator surrounding the rotor, the stator overmolded with a plastic sheath and having an opening on a front side;
a printed circuit board sealing the opening in a fluid-tight manner and, together with the stator, delimiting an interior space through which coolant is flowable, the rotor arranged in the interior space;
an elastic seal arranged between the plastic sheath and the printed circuit board; and
at least two fixing elements arranged on the front side of the stator, the at least two fixing elements connected to the printed circuit board via a plurality of fixing contours.

2. The pump according to claim 1, wherein an annular groove configured to receive the elastic seal is arranged on the front side of the stator.

3. The pump according to claim 1, wherein the elastic seal is a ring seal.

4. The pump according to claim 1, wherein the elastic seal is a sealing lip.

5. The pump according to claim 1, wherein:
the at least two fixing elements includes at least two thermal contact rivets; and
the printed circuit board has at least two through-openings complementary to the at least two thermal contact rivets and through which the at least two thermal contact rivets extend.

6. The pump according to claim 1, further comprising a sensor arranged on a side of the printed circuit board facing the interior space.

7. The pump according to claim 1, further comprising a plurality of reinforcing structures arranged on the plastic sheath.

8. The pump according to claim 1, wherein the printed circuit board includes a coating disposed on a side of the printed circuit board facing the interior space.

9. The pump according to claim 1, wherein the plastic sheath completely covers a side of the stator facing the rotor.

10. The pump according to claim 1, wherein the pump is an oil pump, a coolant pump, and/or a water pump.

11. The pump according to claim 1, wherein the at least two fixing elements are arranged radially outside the elastic seal in a dry region.

12. The pump according to claim 1, wherein:
the at least two fixing elements includes at least two latching elements; and
the plurality of fixing contours includes at least two latching contours complementary to the at least two latching elements and engaged with the at least two latching elements.

13. The pump according to claim 3, wherein the ring seal is an O-ring seal and/or an X-ring seal.

14. The pump according to claim 4, wherein the sealing lip is injection molded onto the plastic sheath.

15. The pump according to claim 5, wherein the plurality of fixing contours includes the at least two through-openings.

16. The pump according to claim 6, wherein the sensor is a temperature sensor and/or a Hall sensor.

17. The pump according to claim 9, wherein a portion of the plastic sheath covering the side of the stator facing the rotor has a thickness of 1 mm or less.

18. A pump, comprising:
an electric motor including a rotor and a stator extending around the rotor, the stator overmolded with a plastic sheath;
a printed circuit board arranged on a front side of the plastic sheath and sealing an opening of the plastic sheath in a fluid-tight manner, the printed circuit board and the plastic sheath at least partially defining an interior space in which the rotor is arranged and through which coolant is flowable;
an elastic seal arranged between the plastic sheath and the printed circuit board; and
a plurality of fixing elements arranged on the front side of the plastic sheath;
wherein the printed circuit board includes a plurality of fixing contours structured and arranged in a complimentary manner to the plurality of fixing elements; and
wherein, when the plurality of fixing elements are engaged with the plurality of fixing contours, i) the printed circuit board is coupled to the plastic sheath via the plurality of fixing elements and ii) the elastic seal is compressed between the plastic sheath and the printed circuit board.

19. The pump according to claim 18, wherein:
at least one fixing element of the plurality of fixing elements is an electrical conductor; and
the electrical conductor extends at least partially through plastic sheath and is soldered to the printed circuit board such that the electrical conductor i) electrically connects the stator and the printed circuit board and ii) physically connects the printed circuit board to the plastic sheath.

20. The pump according to claim 18, wherein the plurality of fixing elements are arranged circumferentially spaced apart from one another along an opening edge of the plastic sheath that defines an outer perimeter of the opening.
